(19) United States
(12) Patent Application Publication
(10) Pub. No.: US 2025/0058568 A1
(43) Pub. Date: Feb. 20, 2025

(54) SYSTEM AND METHOD FOR PRINTING A PATTERN ON A THREE-DIMENSIONAL SURFACE

(71) Applicant: Inter IKEA Systems B.V., LN DELFT (NL)

(72) Inventors: Dan PLATON, Arad (RO); Oleg SHVETS, Älmhult (SE)

(73) Assignee: Inter IKEA Systems B.V., LN DELFT (NL)

(21) Appl. No.: 18/721,835

(22) PCT Filed: Dec. 20, 2022
(86) PCT No.: PCT/EP2022/086861

§ 371 Date: Jun. 19, 2024

(30) Foreign Application Priority Data
Dec. 20, 2021 (SE) 2151559-8

(51) Int. Cl. B41J 3/407; B41J 11/00; B41J 25/316

(52) U.S. Cl. CPC B41J 3/4073; B41J 11/00214; B41J 25/316

(57) ABSTRACT

A system and a method may be provided for printing a pattern on a three-dimensional surface of a work piece. The system may include a printer head configured to apply the pattern on the three-dimensional surface of the work piece and a printer head drive arrangement configured to drive the printer head along a first printer head direction, a second printer head direction orthogonal to the first printer head direction, and about a tilting axis extending orthogonal to the second printer head direction.

### TECHNICAL FIELD

The present invention relates to a system and method for printing a pattern on a three-dimensional surface of a work piece.

### BACKGROUND

In the field of furniture and interior decoration, hardwood materials in solid wood are often preferred by consumers due to their color and look. However, products in such materials are often expensive to produce. Furthermore, the density of such hardwood materials makes them heavy and unsuitable for certain applications. There is thus a need to provide materials which imitates the look of hardwood materials while being cheaper, lighter and easier to produce.

In order to provide such materials a number of methods have been utilized in the past. In some cases, staining is performed to apply a wood pattern imitating more expensive wood material to a cheaper and lighter material. The cheaper and lighter material may be in the form of natural wood such as wood beech, birch or rubberwood or in the form of non-solid wood such as MDF, HDF, wood panels or plywood or a combination of non-solid wood and natural wood such a non-solid wood with a veneer. In a traditional staining method, the work piece is dipped in a conditioner and thereafter wiped before being sprayed with a mixture of water binders and pigments to achieve the intended pattern. If the work piece is in a wood material, the absorption process is difficult to control due to the unpredictable interaction between the wood and the mixture of water binders and pigments. Furthermore, such staining method is unsuitable for work pieces with 3D-surfaces due to its inherent inaccuracy.

To address the issues with traditional staining, the pattern may be printed onto the material by means of digital printing. Such printing methods are described in for example WO 2021148340 and EP 2868478. However, existing printing methods are often unsuitable for work pieces with 3D-surfaces and in particular for printing of multiple articles simultaneously. There is thus need for improvements within this field.

### SUMMARY

According to an aspect a system for printing a pattern on a three-dimensional surface of a work piece is provided. The system comprises a printer head. The printer head is configured to apply the pattern on the three-dimensional surface of the work piece.

The system further comprises a printer head drive arrangement configured to drive the printer head back and forth along a first printer head direction, a second printer head direction orthogonal to the first printer head direction and about a tilting axis extending orthogonal to the second printer head direction.

The system further comprises a work piece unit adapted to hold one or more work pieces and a work piece drive arrangement. The work piece drive arrangement is configured to drive the work piece unit back and forth along a work piece unit direction orthogonal to the first printer head direction and the second printer head direction.

The system further comprises a control system. The control system is operatively connected to the printer head, printer head drive arrangement and work piece drive arrangement.

The control system further comprises a control input interface. The control input interface is configured to receive data associated with the topography/topology of the three-dimensional surface of the work piece. The control system is configured to control the printer head, the printer head drive arrangement and the work piece drive arrangement based on said data associated with the topography of the three-dimensional surface of the work piece to cause relative movement between the printer head and the work piece along the three-dimensional surface and print the pattern on said three-dimensional surface.

Such a system allows for accurate relative movement between the printer head and the work piece along the three-dimensional surface and thereby a more accurate printing process, especially for complex work pieces involving three-dimensional surfaces.

The work piece may be a wood substrate. The wood substrate may be made of natural wood such as beech, birch or rubberwood or may be formed by non-solid wood such as MDF, HDF, wood panels or plywood. Alternatively, the wood substrate may be made of a combination of non-solid wood and natural wood, e.g. solid wood, such as a non-solid wood with a veneer. Thereby, a relatively cheap and light material may be provided with aesthetics similar to a more exclusive hardwood material.

As the skilled person is aware, a veneer is commonly in the form of a solid wood which may be applied to a non-solid wood. The veneer commonly forms an outermost layer of the wood substrate. Thus, in one embodiment, the wood substrate may be formed by a non-solid wood material with a veneer in natural wood.

The pattern may be a wood pattern. The pattern may be obtained from image data depicting natural wood. Thus, a more precise and accurate printing is obtained, with improved appearance of the final work piece.

The printer head may comprise a curing unit. The curing unit is arranged to illuminate the pattern applied by the printer head on the three-dimensional surface. The curing allows for securing the pattern onto the printed surface.

In one embodiment, the printer head is an UV-printer head. The UV-printer head may be configured to apply UV-ink to the three-dimensional surface to print the pattern. UV-printing provides a more long-lasting printing pattern compared to conventional printing.

The UV-printer head may be configured to apply an amount UV-ink of between 2 and 10 g/m² of the three-dimensional surface. Such amounts of UV-ink allow for relatively rapid curing while providing the desired printing accuracy. Preferably, the UV-printer head may be configured to apply an amount of UV-ink of between 4 and 5 g/m² to the three-dimensional surface.

The curing unit may be configured to illuminate the three-dimensional surface of the work piece with UV-light for drying the UV-ink applied by the printer head onto said three-dimensional surface.

In one embodiment, the printer head is a waterborne ink printer head. The waterborne ink printer head is configured to apply waterborne ink to the three-dimensional surface to print the pattern. The curing unit may be configured to illuminate the three-dimensional surface of the work piece with IR-light for drying the waterborne ink applied by the printer head onto said three-dimensional surface.

The first printer head direction, the second printer head direction and the work piece unit direction may correspond to a transversal direction, a depth direction and a length direction of the three-dimensional surface of the work piece, respectively.

The tilting axis may be parallel to the first printer head direction.

The control system may during printing be configured to allow the printing head to follow the topography of the three-dimensional surface and simultaneously control the position of the printer head along the second printer head direction as well as about the tilting axis by means of the printer head drive arrangement and the position of the work piece along work piece unit direction by means of the work piece drive arrangement.

The control system may be configured to cause the printer head to be stationary relative the first printer head direction or the second printer head direction by means of control of the printer head drive arrangement during printing.

Advantageously, the printer head drive arrangement and/or work piece drive arrangement is a CNC-drive arrangement. The control system may comprise a CNC-controller. The CNC-controller is configured to control said CNC-drive arrangement based on the data received by the control input interface. The CNC-controller and CNC-drive arrangement allows for precise printing based on the topography data.

The printer head drive arrangement may comprise a driven member and guiding means. The guiding means extends along the first printer head direction. The driven member is movably mounted to the guiding means. The printer head is mounted to said driven member.

The printer head drive arrangement may further comprise actuating means. The actuating means are connected to the guiding means. The actuating means are configured to move the guiding means along the second printer head direction.

The printer head drive arrangement may comprise a pivot drive. The pivot drive is configured to drive the movement of the printer head about the tilting axis. The pivot drive may connect the printer head and the driven member thereby forming the tilting axis.

In one embodiment, the work piece unit may comprise a table with a fixture arrangement. The fixture arrangement is adapted to retain the work piece. The work piece drive arrangement may comprise a drive member and a guiding track. The guiding track extends along the work piece unit direction. The table is movably mounted to the guiding track. The drive member is configured to drive the table back and forth along the guiding track.

The system may further comprise a first work piece unit and a second work piece unit. Each work piece unit may comprise a table. The work piece drive arrangement may comprise a first and second drive member and a first and second guiding track extending along a first and second work piece unit direction, respectively. The table of the first and second work piece unit may be movably mounted to the first and second guiding track, respectively. The first and second drive member may be configured to drive the table of the first and second work piece unit back and forth along said first and second guiding track, respectively. This reduces set up time since an operator may be able to set up another work piece at the second table during printing on a work piece arranged on the first table.

The work piece may be comprised of a plurality of individual elements, thus allowing printing of several articles during the same printing operation. In one embodiment, a plurality of individual elements may be arranged in parallel next to each along a direction extending parallel to the first or second printer head direction. In one embodiment, a plurality of individual elements is arranged in series next to each along a direction parallel to the work piece unit direction.

The printer head may be configured to apply the pattern on multiple elements simultaneously. Thus, a system which allows for efficient printing of several separate articles is achieved.

According to an aspect, a method for printing a pattern on a three-dimensional surface of a work piece is provided.

The method comprises providing the work piece on the work piece unit and obtaining data associated with the topography of the three-dimensional surface of the work piece via the control input interface. The method further comprises to based on said data align the printer head and the three-dimensional surface of the work piece, print the surface by controlling the printer head, the printer head drive arrangement and the work piece drive arrangement to cause relative movement between the printer head and the work piece along the three-dimensional surface and print the pattern on said three-dimensional surface. Thus, an accurate method for printing a three-dimensional surface is provided.

The printing may further include maintaining the printer head in a stationary position relative the first printer head direction or the second printer head direction while simultaneously moving the work piece along the work piece unit direction and the printer head about the tilting axis to allow the printer head to follow the topography of the three-dimensional surface of the work piece.

The aligning may further comprise moving the printer head and/or work piece such that the printer head is positioned over an initial printing area of the three-dimensional surface of the work piece along the work piece unit direction. The method may further comprise initiating the printing upon the printer head being positioned over said initial printing area and terminating the printing upon the printer head being positioned over a final printing area of the three-dimensional surface of the work piece along the work piece unit direction.

The method may further comprise to after termination of the printing, moving the printer head and/or work piece such that the printer head is positioned over a subsequent initial printing area adjacent to the previous initial printing area relative the first printer head direction. The method may further comprise initiating the printing upon the printer head being positioned over said subsequent initial printing area and terminating the printing upon the printer head being positioned over a subsequent final printing area of the three-dimensional surface of the work piece along the work piece unit direction. The subsequent final printing area is adjacent to the previous final printing area relative the first printer head direction. This allows for accurate printing of wide work pieces which may comprise a plurality of individual elements.

In one embodiment, wherein the work piece is comprised of a plurality of individual elements arranged in parallel next to each other along a direction extending parallel to the first printer head direction. The initial printing area and the final printing area may extend across at least two adjacent individual elements of the work piece along said direction parallel to the first printer head direction.

In one embodiment, the pattern may comprise a plurality of sub-patterns. The printing may further comprise printing a first portion of the three-dimensional surface with a first sub-pattern and printing a second portion of the three-dimensional surface with a second sub-pattern. In one embodiment, the printing further comprises continuously switching between printing the first sub-pattern and the second sub-pattern to form a pattern comprising a plurality of each of the first and second sub-pattern.

The work piece may be a wood substrate. The wood substrate may be made of natural wood such as beech, birch or rubberwood or may be formed by non-solid wood such as MDF, HDF, wood panels or plywood or may be formed by a combination of non-solid wood and natural wood, e.g. solid wood, such as a non-solid wood material with a veneer. Thereby a relatively cheap and light material may provide similar aesthetics to a more exclusive hardwood material. In one embodiment, the wood substrate may be formed by a non-solid wood material with a veneer in natural wood.

In one embodiment, the method further comprises to after the pattern has been printed, applying a sealer to the three-dimensional surface, sanding the three-dimensional surface, and applying a coating to said three-dimensional surface. This allows for a more durable print on the surface.

In on embodiment, the method comprises to after the pattern has been printed, applying a layer of powder coating to the three-dimensional surface. This allows for a more durable print on the surface.

To further ensure the durability of the print and the printed surface, the method may comprise to after the pattern has been printed, applying a clear coating of an UV-cured material. This may be performed by means of rollers or a vacuum coating system.

Further objects and features of the present invention will appear from the following detailed description of embodiments of the invention.

### BRIEF DESCRIPTION OF DRAWINGS

The invention will be described with reference to the accompanying drawings, in which:

FIG. 1 schematically depicts a system for printing according to an embodiment.

FIG. 2 depicts a top view of a work piece according to an example.

FIG. 3 depicts a side view of a work piece according to an example.

FIG. 4 schematically depicts the printing process according to an embodiment.

FIG. 5 schematically depicts a method for printing according to an embodiment.

### DETAILED DESCRIPTION

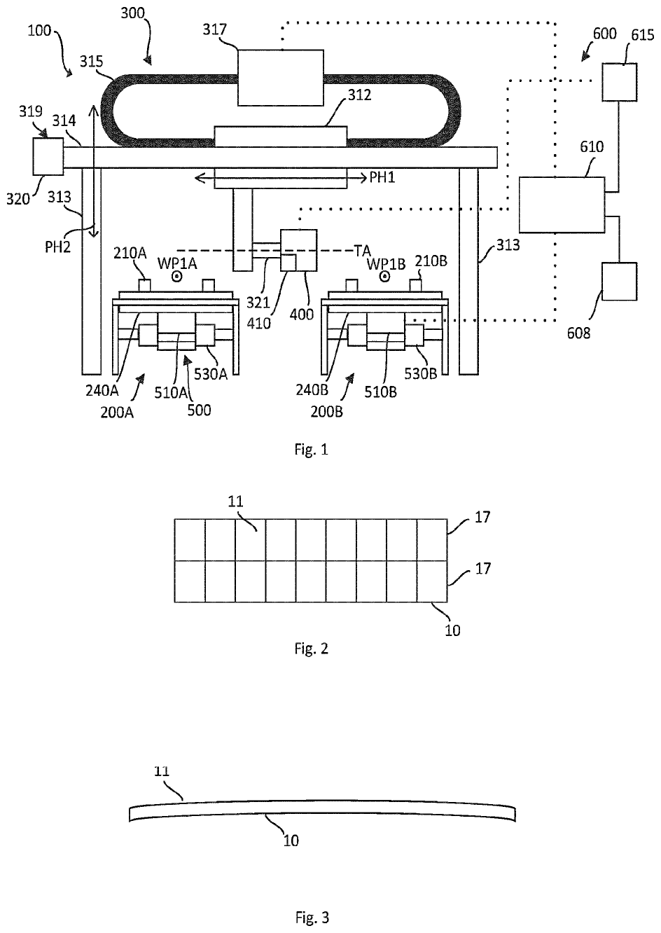

FIG. 1 schematically depicts a system according to an embodiment of the present invention. The system is herein depicted as a modified CNC-rig, however as the skilled person is well-aware, other options of achieving the intended movement of the components may be available. CNC or Computerized Numerical Control herein refers to an automated control of the machinery based on detailed instructions provided by a computer.

The system 100 comprises a printer head 400. The printer head 400 is configured to apply a pattern on a work piece. The system 100 is intended to print a pattern on a three-dimensional surface of a work piece. Accordingly, the system 100 is capable of applying a pattern to a non-flat surface of a work piece, i.e. a three-dimensional surface of a work piece.

A printer head drive arrangement 300 may be provided. The printer head drive arrangement 300 is configured to drive the printer head 400. The printer head drive arrangement 300 is configured to drive the printer head back and forth along a first printer head direction PH1. The printer head drive arrangement 300 is configured to drive the printer head 400 back and forth along a second printer head direction PH2. The second printer head direction PH2 is orthogonal to the first printer head direction PH1. In addition, the printer head drive arrangement 300 is configured to drive the printer head 400 to pivot back and forth about a tilting axis TA. The tilting axis TA extends orthogonally to the second printer head direction PH2.

The system 100 further comprises a work piece unit 200. In the depicted embodiment, the system 100 comprises a first work piece unit 200A and a second work piece unit 200B. The work piece unit 200A, 200B is adapted to hold one or more work pieces. The system 100 may thus comprise a plurality of work piece units.

Similar to the printer head 400, the work piece unit 200A, 200B is driven to achieve relative movement between the printer head 400 and the work piece to be printed. Thus, the system 100 comprises a work piece drive arrangement 500. The work piece drive arrangement 500 is configured to drive the work piece unit 200A, 200B back and forth along a work piece unit direction WP1A, WP1B. The work piece unit direction WP1A, WP1B is orthogonal to the first printer head direction PH1 and the second printer head direction PH2. The first work piece unit 500A is thus movable back and forth along the first work piece unit direction WP1A and the second work piece unit 500B is movable back and forth along the second work piece unit direction WP1B. The first and second work piece unit directions WP1A, WP1B may be parallel.

Preferably, the tilting axis TA is parallel to the first printer head direction PH1.

Advantageously, the first printer head direction PH1 may correspond to a transversal direction of the work piece. The second printer head direction PH2 may correspond to a depth or height direction of the work piece. The work piece unit direction WP1A, WP1B may correspond to a length direction of the work piece. This allows for the printer head 400 to accurately follow the topography of the three-dimensional surface of the work piece during printing.

Preferably, the first printer head direction PH1 and the work piece direction WP1A. WP1B are horizontal directions. The tilting axis may also extend horizontally. The second printer head direction PH2 may extend vertically.

A control system 600 is provided to control the system 100. The control system 600 is thus operatively connected to the printer head 400, the printer head drive arrangement 300 and the work piece drive arrangement 500. The control system may be operatively connected to said components by means of any conventional data connection, such as wired connections or wireless connections such as for example Wi-Fi, Bluetooth, mobile network etc.

The control system comprises a control input interface 608. The control input interface 608 is configured to receive data associated with the topography of the three-dimensional surface of the work piece, i.e. the three-dimensional surface onto which the intended pattern is to be printed.

The control input interface 608 may be comprised in a computer forming a part of the control system 600. The control input interface 608 is configured to receive data associated with the topography of the three-dimensional surface of the work piece. The data may be provided as programmed code such as a CAD-model (Computer Aided Design) and/or numerical topography data defining the geometry of the work piece and the topography of the three-dimensional surface.

The control system 600 is configured to control the printer head 400, the printer head drive arrangement 300 and the work piece drive arrangement 500 based on the aforementioned data. The control system 600 is configured to control said components to cause relative movement between the printer head and the work piece along the three-dimensional surface, i.e. the three-dimensional surface to be printed, and print the pattern on the three-dimensional surface.

The pattern may be a wood pattern. The wood pattern may be based on image data depicting a wooden surface. Accordingly, the control input interface 608 may be configured to receive image data associated with an intended print pattern, whereby the control system 600 is configured to control the system to print a pattern based on said intended print pattern. Said intended print pattern is preferably a modified image of real wood. The real image may be further modified by means of imaging software.

Preferably, the system is in the form a CNC-rig. Thus, the printer head drive arrangement 300 may be CNC-drive arrangement. Alternatively or additionally, the work piece drive arrangement may be a CNC-drive arrangement. The control system may thus comprise a CNC-controller 610. The CNC-controller 610 may be configured to control any one or both of the CNC-drive arrangements. The CNC-controller 610 may be comprised in a computer.

During the printing operation, the control system 600 is configured to allow the printing head 400 to follow the topography of the three-dimensional surface of the work piece. During the printing operation, the control system 600 is further configured to simultaneously control the position of the printer head 400 along the second printer head direction PH2 and about the tilting axis TA as well as the position of the work piece along the work piece unit direction. The control of the position of the printer head 400 is provided by means of said control system 600 controlling the printer head drive arrangement 300. The control of the position of the work piece is provided by means of control of the position of the work piece drive arrangement 500. The control system 500 thus controls the position of the work piece unit 500A, 500B and thereby the position of the work piece.

To increase printing accuracy, the control system 600 is configured to cause the printer head 400 to be at least temporary stationary relative the first printer head direction PH1 or the second printer head direction PH2 by means of control of the printer head drive arrangement 300 during printing.

The drive arrangements for the printer head as well as the work piece unit may be based on any type of conventional drive principles to achieve the intended movement along the above described directions.

As depicted, the printer head drive arrangement 300 may comprise a driven member 312. The printer head drive arrangement 300 may further comprise guiding means 314. The guiding means 314 extends along the first printer head direction PH1. The driven member 312 is movably mounted to the guiding means 314 and the printer head 400 is mounted to the driven member 312. As depicted the printer head drive arrangement may comprise a belt drive. The driven member 312 is this mounted to a belt 315. The belt is driven by a belt drive unit 317. The driven member 312 is movably connected to the guiding means 314 which may be formed as a track. The belt 315 as well as the track extends along the first printer head direction PH1.

The printer head drive arrangement 300 may comprise actuating means 319. The actuating means 319 are connected to the guiding means 314. The actuating means 319 may be configured to move the guiding means 314 along the second printer head direction PH2. In one embodiment, the actuating means 319 comprises an actuation unit 320 configured to drive the guiding means 314 along the second printer head direction PH2. The actuating means 319 further comprises actuation guiding means 313. The actuation guiding means 313 extends along, e.g. parallel to, the second printer head direction 313. The guiding means 314 is movably connected to the actuation guiding means 313. In one embodiment, the guiding means 314 may be provided with a gear, whereby the actuation guiding means 313 comprises a gear rack in engagement with said gear thus allowing for the movement of the guiding means 314. The gear is driven by the actuation unit 320. As depicted, the actuation means 319 may comprise a pair of actuation guiding means 313, whereby the guiding means 314 is movably connected to each one of the pair of actuation guiding means 313.

To enable pivoting of the printer head 400, the printer head drive arrangement 300 may comprise a pivot drive 321. The pivot drive 321 is configured to drive the movement of the printer head 400 about the tilting axis TA. The pivot drive 321 may comprise a pivot drive unit driving a pivot shaft extending along the tilting axis TA. Thus, the pivot drive 400 may connect the printer head 400 and the driven member 312, thereby forming the tilting axis TA.

As depicted in FIG. 1, the work piece unit 200A, 200B may comprise a table 240A, 240B. The table 240A, 240B may comprise a fixture arrangement 210A, 210B. The fixture arrangement 210A, 210B is adapted to retain the work piece.

In order to drive the movement of the work piece unit 200A, 200B. The work piece drive arrangement 500 may comprise a drive member 510A, 510B and a guiding track 530A, 530B. The guiding track 530A, 530B extends along the work piece unit direction WP1A, WP1B. The table 240A, 240B is movably mounted to the guiding track 530A, 530B. The drive member 510A, 510B is configured to drive the table 240A, 240B back and forth along the guiding track 530A, 530B.

The drive member 510A, 510B may be connected to a driven transmission element in engagement with the guiding track 530A, 530B. The drive member 510A, 510B is thus fix in relation to the table 240A, 240B to allow for movement of the table 240A, 240B along the guiding track 530A, 530B.

As shown in FIG. 1, the first work piece unit 200A may comprise the table 240A. The work piece drive arrangement 500 may thus comprise a first drive member 510A and a first guiding track 530A extending along the first work piece unit direction WP1A. The table 240A of the first work piece unit 200A is movably mounted to the first guiding track 530A. The first drive member 510A is configured to drive the table of the first work piece unit 200A back and forth along the first guiding track 530A. Similarly, the second work piece unit 200B may comprise the table 240B. The work piece drive arrangement 500 may thus comprise a second drive member 510B and a second guiding track 530B extending along the second work piece unit direction WP1B. The table 240B is movably mounted to the second guiding track 530B. The second drive member 510B is configured to drive the table 240B of the second work piece unit 200B back and forth along the second guiding track 530B.

The printer head 400 may be an ink-printer head with an ink delivery system. The ink delivery system may comprise one or more reservoirs for storing the ink as well as ink applicators in fluid connection with said reservoirs. Said ink applicators may be configured to apply droplets of ink onto the three-dimensional surface of the work piece to print the intended pattern. To control the operation of the printer head 400, the control system 600 may comprise a printer head controller 615. The printer head controller 615 is operatively connected to the printer head 400 and configured to control said printer head 400.

In order to avoid “bleeding” of the printed pattern and the applied droplets of ink to spread, the printer head 400 may comprise a curing unit 410. The curing unit 410 is arranged to illuminate the pattern applied by the printer head 400 on the three-dimensional surface of the work piece.

The curing unit 410 is thus adapted to illuminate the ink droplets applied by the ink applicators. Preferably, the curing unit 410 is arranged such that it instantly illuminates the ink droplets after application, whereby the ink droplets are cured before bleeding may occur. The curing unit 410 may comprise an illuminating unit in the form of a lamp.

As the skilled person is aware, there are multiple available options available for digital printing. The system may thus implement any type of suitable conventional digital printer head.

In one embodiment, the printer head 400 is an UV-printer head. The UV-printer head is configured to apply UV-ink to the three-dimensional surface to print the pattern. Preferably, the UV-printer head is configured to apply an amount of UV-ink of between 2 and 10 g/m² of the three-dimensional surface of the work piece. An UV-printer head utilizes UV-light (ultraviolet light) for curing. The UV-ink is thus adapted and intended to be cured by said UV-light. Accordingly, the curing unit 410 may be configured to illuminate the three-dimensional surface of the work piece with UV-light for drying the UV-ink applied by the printer head 400 onto said three-dimensional surface.

In one embodiment, the printer head 400 is a waterborne ink printer head. The waterborne ink printer head is configured to apply waterborne ink to the three-dimensional surface to print the pattern. The waterborne ink printer head may utilize IR-light (Infrared light) for curing. The waterborne ink is thus adapted and intended to be cured by said IR-light. Accordingly, the curing unit 410 may be configured to illuminate the three-dimensional surface of the work piece with IR-light for drying the waterborne ink applied by the printer head 400 onto said three-dimensional surface.

Turning to FIGS. 2 and 3, examples on work pieces are depicted. The work piece 10 has at least one three-dimensional surface 11. The work piece 10 may be comprised of a plurality of individual elements 17. Alternatively, the work piece 10 may be in a single solid piece.

As depicted in FIG. 2, a plurality of individual elements may be arranged in parallel next to each other along a direction extending parallel to the first printer head direction PH1. In one embodiment, a plurality of individual elements 17 may be arranged in series next to each other along a direction parallel to the work piece unit direction WP1A, WP1B.

Preferably, the individual elements are arranged adjacent to each other in order to minimize gaps in the work piece.

Based on the size of the printer head as well as the individual elements, the printer head 400 may be configured to apply the pattern on multiple individual elements 17 simultaneously.

The work piece 10 may be a wood substrate. In one embodiment, the wood substrate may be made of natural wood such as beech, birch or rubberwood. In one embodiment, the wood substrate is formed by non-solid wood such as MDF, HDF, wood panels or plywood. In one embodiment, the wood substrate may be made of a combination of natural wood, e.g. solid wood, and non-solid wood such as non-solid wood provided with a veneer.

Preferably, the system is intended to print three-dimensional surfaces of furniture components such as back rests for chairs, chair legs, table legs etc. The entire work piece may form a furniture component. Alternatively, each individual element of the work piece may constitute a furniture component or part thereof.

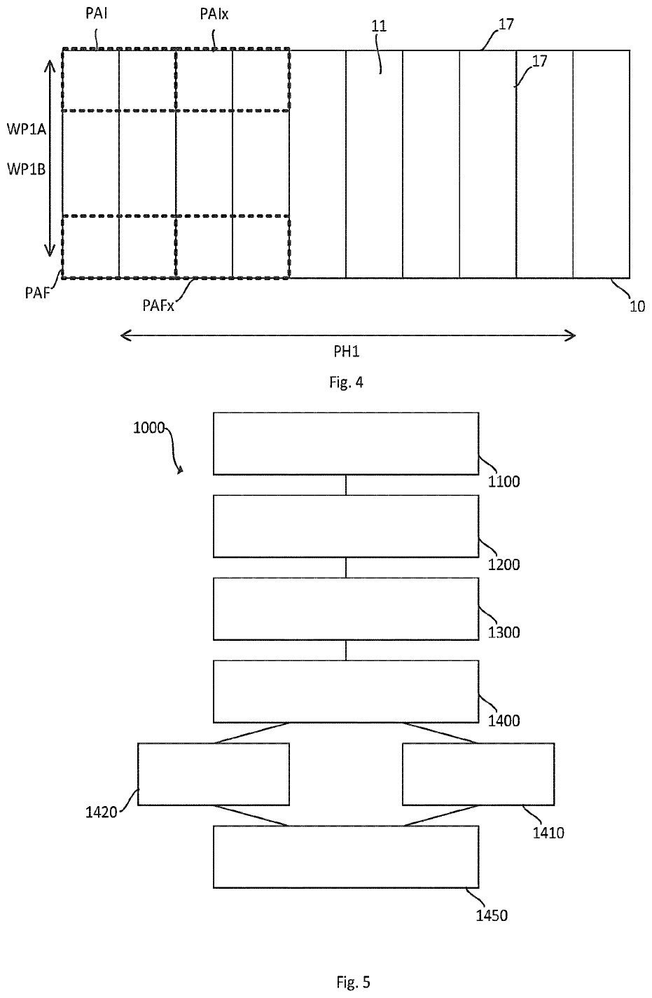

FIGS. 4 and 5 depict aspect of a printing method utilizing the system described with reference to FIG. 1.

The method 1000 comprises providing 1100 the work piece 10 on the work piece unit. In one embodiment, the work piece 10 is retained to the table of the work piece unit by means of the fixture arrangement.

Before or after the work piece 10 is provided on the work piece unit, data is obtained 1200. The data is associated with the topography of the three-dimensional surface 11 of the work piece 10. The data is obtained via the control input interface of the control system, e.g. by receiving data of a digital model of the work piece 10.

Before printing is initiated, the printer head and the three-dimensional surface 11 of the work piece 10 are aligned 1300. After alignment, printing 1400 is initiated. Thus, the method comprises printing 1400 the surface 11 by controlling the printer head, the printer head drive arrangement and the work piece drive arrangement to cause relative movement between the printer head and the work piece 10 along the three-dimensional surface 11 of the work piece 10 and printing the pattern on said three-dimensional surface 11 of the work piece 10. The control of the printing 1400 and the aligning 1300 is based on the obtained data.

The step of printing 1400 may further include maintaining 1410 the printer head in a stationary position relative the first printer head direction or the second printer head direction while simultaneously moving the work piece 10 along the work piece unit direction WP1A, WP1B and the printer head about the tilting axis to allow the printer head to follow the topography of the three-dimensional surface 11 of the work piece 10. Typically, tilting is performed for keeping the printer head aligned with the normal direction of the work piece 10.

FIG. 4 schematically depicts the relative movement between the printer head and the work piece 10 during aligning of the work piece 10 as well as during printing.

The step of aligning 1300 may comprise moving the printer head and/or work piece such that the printer head is positioned over an initial printing area PAI of the three-dimensional surface 11 of the work piece 10. The printer head and/or work piece is moved along the work piece unit direction WP1A, WP1B.

Upon the printer head being positioned over the initial printing area PAI printing is initiated. Correspondingly, the printing is terminated 1450 upon the printer head being positioned over a final printing area PAF of the three-dimensional surface 11 of the work piece 10. The initial printing area PAI and the final printing area PAF are positioned along the work piece unit direction WP1A, WP1B. Accordingly, printing is initiated and conducted on the three-dimensional surface 11 along the work piece unit direction WP1A, WP1B between the initial printing area PAI and the final printing area PAF.

In one embodiment, the initial printing area PAI and the final printing area PAF extends across the entire width of the work piece 10 along the first printer head direction PH1. Thus, the entire three-dimensional surface 11 is printed during a single printing operation.

In cases where the final printing area PAI and/or the final printing area PAF does not extend across the entire width of the work piece 10 along the first printer head direction PH1, additional printing operations may be required.

Accordingly, the method 1000 may further comprise to after printing 1400, move the printer head and/or work piece 10 such that the printer head is positioned over a subsequent initial printing area PAIx. The subsequent initial printing area PAIx is positioned adjacent to the initial printing area PAI relative the first printer head direction PH1. Upon the printer head being positioned over the subsequent initial printing area, printing 1400 is initiated. Similar to what is described below, the printing 1400 is terminated 1450 upon the printer head being positioned over a subsequent final printing area PAFx of the three-dimensional surface 11. The subsequent final printing area PAFx and the subsequent initial printing area PAIx are positioned along the work piece unit direction WP1A, WP1B. The subsequent final printing area PAFx is adjacent to the previous final printing area PAF relative the first printer head direction PH1. This process may be repeated until the entire three-dimensional surface 11 is printed with the pattern. Accordingly, printing is repeated along the work piece unit direction WP1A, WP1B across the length of the work piece, whereby the relative positioning of the printer head and the work piece 10 is incrementally altered each printing operation along the first printer head direction PH1. This type of printing method allows for accurate and precise printing of the pattern.

In one embodiment, the pattern to be printed may comprise a plurality of sub-patterns. For example, the pattern may include a first sub-pattern in the form of text and second sub-pattern in the form of a wood structure or different sub-patterns arranged subsequently each of which resembling a different wood structure. The printing 1400 may thus further comprise printing a first portion of the three-dimensional surface 11 with a first sub-pattern and printing a second portion of the three-dimensional surface 11 with a second-sub-pattern. In one embodiment, the printing 1400 may further comprise continuously switching between printing the first sub-pattern and the second sub-pattern to form a pattern comprising a plurality of each of the first and second sub-pattern.

In order to safeguard the integrity of the printed pattern and the printed surface, the three-dimensional surface 11 of the work piece 10 may be treated and/or coated after the pattern has been printed.

In one embodiment, a sealer is applied to the three-dimensional surface after the pattern has been printed. As is well known in the arts, a sealer is a coating applied to a printed surface to fix the ink in place and reduce the risk for smudging. After the sealer has been applied, the three-dimensional surface may be sanded prior to the application of a coating for protecting the surface.

In one embodiment, a layer of powder coating may be applied to the three-dimensional surface 11 after the pattern has been printed. Preferably, only a single layer of coating is applied if such a powder coating is applied.

In one embodiment, a clear coating of an UV-cured material may be applied to the three-dimensional surface 11 after the pattern has been printed. In one embodiment, the clear coating of the UV-cured material is applied by means of rollers, such as vertical or horizontal rollers, or a vacuum coating system.

The invention has been described above in detail with reference to embodiments thereof. However, as is readily understood by those skilled in the art, other embodiments are equally possible within the scope of the present invention, as defined by the appended claims.

1. A system for printing a pattern on a three-dimensional surface of a work piece, the system comprising:
a printer head configured to apply the pattern on the three-dimensional surface of the work piece;
a printer head drive arrangement configured to drive the printer head back and forth along a first printer head direction, back and forth along a second printer head direction that is orthogonal to the first printer head direction, and about a tilting axis extending orthogonal to the second printer head direction;
a work piece unit adapted to hold one or more work pieces;
a work piece drive arrangement configured to drive the work piece unit back and forth along a work piece unit direction that is orthogonal to the first printer head direction and the second printer head direction;
a control system operatively connected to the printer head, the printer head drive arrangement, and the work piece drive arrangement;
wherein the control system includes a control input interface configured to receive data associated with a topography of the three-dimensional surface of the work piece;
wherein the data is provided as programmed code and/or numerical topography data defining a geometry of the work piece and the topography of the three-dimensional surface of the work piece;
wherein the control system is configured to control the printer head, the printer head drive arrangement, and the work piece drive arrangement based on the data to cause relative movement between the printer head and the work piece along the three-dimensional surface and print the pattern on the three-dimensional surface.

2. The system according to claim 1, wherein the work piece is a wood substrate made of natural wood or formed by non-solid wood or formed by a combination of non-solid wood and natural wood.

3. The system according to claim 1, wherein the pattern is a wood pattern.

4. The system according to claim 3, wherein the pattern is obtained from image data depicting natural wood.

5. The system according to claim 1, wherein the printer head comprises a curing unit arranged to illuminate the pattern applied by printer head on the three-dimensional surface.

6. The system according to claim 5, wherein the printer head is a UV-printer head configured to apply UV-ink to the three-dimensional surface to print the pattern.

7. The system according to claim 6, wherein the UV-printer head is configured to apply an amount of UV-ink of between 2 and 10 g/m² of the three-dimensional surface.

8. The system according to claim 6, wherein the curing unit is configured to illuminate the three-dimensional surface of the work piece with UV-light for drying the UV-ink applied by the printer head onto the three-dimensional surface.

9. The system according to claim 5, wherein the printer head is a waterborne ink printer head configured to apply waterborne ink to the three-dimensional surface to print the pattern.

10. The system according to claim 9, wherein the curing unit is configured to illuminate the three-dimensional surface of the work piece with IR-light for drying the waterborne ink applied by the printer head onto the three-dimensional surface.

11. The system according to claim 1, wherein the first printer head direction, the second printer head direction, and the work piece unit direction respectively correspond to a transversal direction, a depth direction, and a length direction of the three-dimensional surface of the work piece.

12. The system according to claim 1, wherein the tilting axis is parallel to the first printer head direction.

13. The system according to claim 1, wherein the control system is during printing configured to allow the printing head to follow the topography of the three-dimensional surface, and simultaneously control the position of the printer head along the second printer head direction as well as about the tilting axis by means of control of the printer head drive arrangement and control the position of the work piece along the work piece unit direction by means of control of the work piece drive arrangement.

14. The system according to claim 13, wherein the control system is configured to cause the printer head to be stationary relative the first printer head direction or the second printer head direction by means of control of the printer head drive arrangement during printing.

15. The system according to claim 1, wherein the printer head drive arrangement and/or work piece drive arrangement is a CNC-drive arrangement; and
wherein the control system comprises a CNC-controller configured to control the CNC-drive arrangement based on the data received by the control input interface.

16. The system according to claim 1, wherein the printer head drive arrangement comprises a driven member and guiding means extending along the first printer head direction;
wherein the driven member is movably mounted to the guiding means; and
wherein the printer head is mounted to the driven member.

17. The system according to claim 16, wherein the printer head drive arrangement comprises actuating means connected to the guiding means; and
wherein the actuating means is configured to move the guiding means along the second printer head direction.

18. The system according to claim 16, wherein the printer head drive arrangement comprises a pivot drive configured to drive the movement of the printer head about the tilting axis.

19. The system according to claim 18, wherein the pivot drive connects the printer head and the driven member thereby forming the tilting axis.

20. The system according to claim 1, wherein the work piece unit comprises a table with a fixture arrangement adapted to retain the work piece;
wherein the work piece drive arrangement comprises a drive member and a guiding track extending along the work piece unit direction;
wherein the table is movably mounted to the guiding track; and
wherein the drive member is configured to drive the table back and forth along the guiding track.

21. The system according to claim 20, further comprising a first work piece unit and a second work piece unit, each comprising a table;
wherein the work piece drive arrangement comprises a first and a second drive member and a first and a second guiding track extending along a first and a second work piece unit direction, respectively;
wherein the table of the first and the second work piece unit is movably mounted to the first and the second guiding track, respectively; and
wherein the first and the second drive member are configured to drive the table of the first and the second work piece unit back and forth along the first and the second guiding track, respectively.

22. The system according to claim 1, wherein the work piece is comprised of a plurality of individual elements.

23. The system according to claim 22, wherein the plurality of individual elements is arranged in parallel next to each other along a direction extending parallel to the first printer head direction.

24. The system according to claim 22, wherein the plurality of individual elements is arranged in series next to each other along a direction parallel to the work piece unit direction.

25. The system according to claim 22, wherein the printer head is configured to apply the pattern on multiple individual elements simultaneously.

26. A method for printing a pattern on a three-dimensional surface of a work piece utilizing the system according to claim 1, the method comprising:
providing the work piece on the work piece unit;
obtaining data associated with the topography of the three-dimensional surface of the work piece via the control input interface, wherein the data is provided as programmed code and/or numerical topography data defining the geometry of the work piece and the topography of the three-dimensional surface of the work piece;
aligning the printer head and the three-dimensional surface of the work piece;
printing the surface by controlling the printer head, the printer head drive arrangement, and the work piece drive arrangement to cause relative movement between the printer head and the work piece along the three-dimensional surface and printing the pattern on the three-dimensional surface.

27. The method according to claim 26, wherein the printing further includes maintaining the printer head in a stationary position relative to the first printer head direction or the second printer head direction while simultaneously moving the work piece along the work piece unit direction and moving the printer head about the tilting axis to allow the printer head to follow the topography of the three-dimensional surface of the work piece.

28. The method according to claim 27, wherein the aligning further comprises moving the printer head and/or the work piece such that the printer head is positioned over an initial printing area of the three-dimensional surface of the work piece along the work piece unit direction; and
wherein the method further comprises initiating the printing upon the printer head being positioned over the initial printing area and terminating the printing upon the printer head being positioned over a final printing area of the three-dimensional surface of the work piece along the work piece unit direction.

29. The method according to claim 28, further comprising:
after terminating the printing, moving the printer head and/or the work piece such that the printer head is positioned over a subsequent initial printing area adjacent to the initial printing area relative to the first printer head direction;
initiating the printing upon the printer head being positioned over the subsequent initial printing area and terminating the printing upon the printer head being positioned over a subsequent final printing area of the three-dimensional surface of the work piece along the work piece unit direction, the subsequent final printing area being adjacent to the final printing area relative to the first printer head direction.

30. The method according to claim 28, wherein the work piece is comprised of a plurality of individual elements arranged in parallel next to each other along a direction extending parallel to the first printer head direction; and
wherein the initial printing area and the final printing extend across at least two adjacent individual elements of the work piece along a direction parallel to the first printer head direction.

31. The method according to claim 26, wherein the pattern comprises a plurality of sub-patterns; and
wherein the printing further comprises printing a first portion of the three-dimensional surface with a first sub-pattern and printing a second portion of the three-dimensional surface with a second sub-pattern.

32. The method according to claim 31, wherein the printing further comprises continuously switching between printing the first sub-pattern and the second sub-pattern to form a pattern comprising a plurality of each of the first and the second sub-patterns.

33. The method according to claim 26, wherein the work piece is a wood substrate made of natural wood or formed by non-solid wood or formed by a combination of non-solid wood and natural wood.

34. The method according to claim 33, further comprising, after printing the pattern, applying a sealer to the three-dimensional surface, sanding the three-dimensional surface, and applying a coating to the three-dimensional surface.

35. The method according claim 33, further comprising, after printing the pattern, applying a layer of powder coating to the three-dimensional surface.

36. The method according to claim 33, further comprising to after the pattern has been printed, applying a clear coating of an UV-cured material by means of rollers or a vacuum coating system.
